(19) United States
(12) Patent Application Publication
(10) Pub. No.: US 2015/0121422 A1
(43) Pub. Date: Apr. 30, 2015

(54) METHOD FOR CREATING NEW DISTRIBUTION CHANNELS FOR TARGETED, AUTOMATED, CONTEXT AND RELEVANCE DRIVEN ENGAGEMENT, INTERACTION, COMMUNICATION, COMMUNITY BUILDING, COOPERATION, AND PERSONALIZED, DEDICATED INFORMATION, DATA, AND MEDIA CONTENT DISTRIBUTION, AND CONSUMPTION

(71) Applicant: Fyuuuz AG, Oberriet (CH)

(72) Inventor: Arnold Schmidt, Heiden (CH)

(73) Assignee: Fyuuuz AG, Oberriet (CH)

(21) Appl. No.: 14/523,273

(22) Filed: Oct. 24, 2014

Related U.S. Application Data
(60) Provisional application No. 61/895,720, filed on Oct. 25, 2013.

(51) Int. Cl. H04N 21/2668; H04N 21/414; H04N 21/61; H04N 21/81

(52) U.S. Cl. CPC H04N 21/2668; H04N 21/812; H04N 21/41407; H04N 21/6131
USPC 725/34

(57) ABSTRACT

A method for targeted, relevance driven, communication, interaction, engagement, community building, and personalized media content distribution, and consumption on a mobile telephone or television comprising detecting and interpreting a signal that previously has been given one or more functional contexts in order to display one from a plurality of performances contained within a single broadcast signal according to predefined specifications defined for the signal. The signal is digitally detecting the face of a person or an object, detecting a bar code, and/or detecting a sound. At least one predetermined advertisement or message is broadcast to a recipient based on the signal.

### CROSS-REFERENCE TO RELATED APPLICATION

This application is a non-provisional utility patent application, and claims the benefit of U.S. Provisional Patent Application Ser. No. 61/895,720, filed on Oct. 25, 2013 which is expressly incorporated herein in its entirety by reference thereto.

### FIELD OF THE INVENTION

The present invention relates to improved marketing and advertising methods and systems. The invention further relates to improved methods of communication and monetization. The invention also relates to dynamic methods to deliver one of a plurality of predetermined outputs to users where new outputs are added by the users and also non-users of the method according to the invention. The invention further relates to signal generation and recognition technologies, including biometrical pattern/object/sound/color recognition technologies and correlation methods included therewith. The present invention also relates to applications for mobile devices and methods used on mobile devices to create or trigger an output on the mobile device, e.g., a message, an application, a playback, or a profile. The invention furthermore relates to methods to deliver one of a plurality of predetermined contexts and performances on a single signal to a user based on a user's profile.

### BACKGROUND OF THE INVENTION

Existing broadcast technologies include the broadcast of a single context, and a single performance, out for presentation/viewing. No matter where the viewer is, when tuning in to that broadcast the content displayed is the same because it is one broadcast. Family members all watch the same content on the same screen. Whether the viewer is a child or an adult, male or female, the broadcast is the same and the viewers all see the same performance. Existing broadcast technologies face the challenge of not establishing a direct and automated engagement with their viewers over the TV screen.

Existing advertising methods include the placement of commercials during a performance. Advertising companies and marketing strategies include placement of the commercial at a time and during a broadcast where the desired demographic of viewer will see the commercial for the product or service. For example, it is very common to place and see commercials for beer and alcohol during a broadcast for a sporting event (e.g., the Superbowl) because the advertisers know the desired adult demographic is watching the event. Even for the biggest of sporting events, or other broadcasts that are of highest viewership, advertisers face the challenge that the TV audience does not always match with the same target profile as the ones they wish to address their messages to. Those beer and alcohol commercial advertisements during the Superbowl are much less effective, if at all, to underage children who also watch the broadcast. There is a high percentage of wastage in existing advertising technologies and methods and they can also generate a negative impact in those who do not belong to the targeted audience.

Existing communication channels for broadcasters are the Terrestrial, Satellite, Cable and Internet technologies, and although their segmentation through the amount of more Media Providers grew, the targeted segmentation of their content did not follow to improve at the same time.

Existing advertising methods are expensive in their production and targeted distribution. A message is included into a commercial spot, and the spot is broadcasted. To make any sudden changes to the message is partly not possible or generates further high expenses.

The same problems that are described above in the context of television broadcasts also applies to other forms of media, such as, for example, print, billboards, or the internet. And more and more content is being viewed on devices other than a television such as computers and smartphones. The advertising methods and technologies for those contexts is no different in that they share the same disadvantages and flaws. The advertisements are placed based on who the advertisers think will be viewing the content but the actual viewer is not really known resulting in inefficient advertising.

It would be beneficial to have an improved method for distributing messages and advertisements to people based on the actual profile of the viewer. This lowers the wastage, avoids delivering improper messages to the wrong viewership and creating a negative impact, and would please the viewer to receive messages and information that suites him, because suiting his profile. It would be beneficial to the advertiser and to the viewer for the viewer to see advertisements relevant to the viewer and not advertisements directed to other age groups or demographics. It would be beneficial to have an advertising method that allows a viewer to effectively preselect the types of advertisements it wants to see based on a profile for the viewer than could then be used to select and have displayed one from a plurality of advertisements broadcast in single broadcast signal. It would be beneficial to have a dynamic method for distributing messages and information through signals that continuously can be updated and evolves also based on user inputs and profiles. Such a method would provide improved advertising and marketing techniques resulting in greater efficiency and effectiveness.

### SUMMARY OF THE INVENTION

The present invention overcomes the foregoing and other shortcomings and drawbacks associated with currently available marketing and advertising technologies. While the invention will be described in connection with certain embodiments, it will be understood that the invention is not limited to those embodiments. To the contrary, the invention includes all alternatives, modifications and equivalents as may be included within the spirit and scope of the present invention.

The present invention is a method for advertising and marketing for both the advertisers and for the viewers. The present invention is an improved method for communication, data, and message delivery, and advertising, with an increased effective rate because the particular advertisement seen by a specific viewer is selected instantly from various advertisements based on the actual profile of the viewer. The present invention is also an improved method for viewers to select the advertisements they see based on their actual profile rather than the demographic for the broadcast or the trends of the user on a computer.

The invention is a method to deliver one of a plurality of predetermined performances contained within a single broadcast signal to a user based on a user's profile. The method according to the invention comprises detecting and interpreting a signal that previously has been given one or more functional contexts in order to communicate, interact, engage, and experience one or more performances according to predefined specifications defined for said signal, wherein said signal is one from the group selected from digitally detecting the face of a person, an object, and/or a profile, and outputting at least one predetermined specification to a recipient via a television, a mobile telephone, and/or computer.

Any signal that is detected (e.g., a human face, 2D code, pattern, color, vibration, sound, etc.) can be interpreted after being labeled. Labeling means defining one or more contexts (and performances) related to it. Users retrieve their own specific context upon their profile criteria according to the contexts added to the signal.

The present invention provides a new method that enables advertisers to deliver customized and personalized multiple messages upon one single television signal so that all family members retrieve their own personal contexts to that television signal. The specific context and performance experienced by the user depends on the identification of the user, and their user profile.

The context of the same signal, which is a TV show for example, for a male adult could be a quiz, the performance could be a quiz on the convertible car the actors are driving in (the price could be a test drive of the car), while for a female adult the context could be shopping, and the performance could be the bag, the female actor is wearing, while for the child the performance could be a voting, and the performance would be: what name should the puppy in the car be given.

Users of any digital platforms face the challenge that their profiles are monetized by the platform operators. Present invention gives users the opportunity to monetize their profiles themselves. Their context to a labeled signal is dependent on their profile criteria. An implemented micro payment system enables them to exchange data, information, and content for prices they define themselves.

TV stations, product owners and retailers all face the challenge that they do not have first-hand data on their viewers, customers, consumers, and their customers don't interact with their products directly, over the product. They also face the challenge that with their customers there is no personalized exchange of information, no direct engagement and monetization opportunities. The present invention enables them to automatically engage with their customers whenever they detect their signal, to build context based communities whenever their customers retrieve their personal context to a labeled signal, which can be a TV show, a product, or any other labeled item, while it gives them both monetization opportunities.

For example, a TV Station finds out about an accident in a city. The station sends out a targeted message to those profile owners who are located in the area, asking them to send snapshots and videos from the scene. The users send back images and videos, and will be paid for their service.

The technology (method) relates to customized broadcasts and performances and multiple broadcasts including multiple performances, one or more of which can be displayed and are displayed based on labeled signals. The invention provides a method for signals to be detected, which carry one or more contexts with one or more performances. A signal can be a television show, that when labeled is given customized contexts so that although every viewer views the same content, when detecting the signal each one will retrieve their own customized and personalized context. The same when detecting a product, an image (pattern), a color, a vibration, a sound, or a person's face.

### DESCRIPTION OF THE DRAWINGS

Not applicable.

### DETAILED DESCRIPTION

The present invention is an organic network consisting of living organisms like people or a flower, or of objects like a house or a teacup, or of products like a soft drink can, or of chemical substances like water, or of physical phenomena such as sound, or shapes, images, colors, codes, time or space. These are interpreted as detectable signals that have been given new contexts. The “organic network” means the network of all things, living or non-living; in which correlation like interaction and engagement have a semantic context driven by the—usually current—factor of relevance. The operation and use of the invention is a new, and a newly enjoyable user experience.

To fyuz is to perform a fyuuuz action: fyuser to start a function that detects and interprets a signal that previously has been given one or more functional contexts in order to communicate, interact, engage, and experience one or more performances according to the targeting specifications defined in the particular fyuuuuz action. For example: fyuser to start a function to detect a face and interpret the face as to identify a person. The signal, or the “face of this particular person” has been given the functional context “playback a specific video with a payment option” to “a specific profile of a person—which is the fyuser—in accordance with the predefined targeting specification of this specific fyuuuuz action. A fyuser is the targeted recipient participant.

Multiple fyuuuz actions may be added to the same label, while multiple contexts may be added to the same signal. Fyuuuzing means merging and the building of fyuuuz communities at the same time.

Giving a signal a functional context means labeling. A signal with a context is called a label. Labeling does not mean tagging as known today in its conventional sense, which is marking something or someone for identification or classification purposes. Labels may have single or multiple functional contexts. These contexts make the execution of one or more performances possible.

The method and system of the present invention is a new and unique methodology for processing and converting any quantity exhibiting variation in time or space. These variations may be organic or chemical substances, images, audio signals, vibration, video (as a sequence of images), speech, communication, geophysical location, sonar, voice, radar and medical signals. Detecting the output of a thermocouple, which conveys temperature information, or the output of a pH meter, which conveys acidity information, biometric, numeric, alphabetic signals as well as brightness, color, motion, range, position, orientation and pressure, or space coordinates as a function of a two-dimensional location of electromagnetic waves, or physical objects, which are potentially signals that may be labeled. These labels provide a context to/information on the status of a physical condition. To convey a message between peers to another form of output, utilizing an automated process to detect, identify, interpret/execute the context of existing signals. This process triggers and delivers multiple personalized applications/multiple personalized data to multiple targeted/expecting recipients participants with multiple profiles to establish the connection/evaluate and operate the network. Fyuuuz establishes the relation and correlation between two or more participants, considering factors that are considered as relevant. An endless number of context related engagements and networks are possible.

Labels may execute single or multiple performances according to fyuser's profile parameters, and/or any quantity exhibiting variation in time or space. Single/multiple/semantically/personalized outputs and application performances may be the following: Logging into a web user account, a group, a community, a forum, or a chat; Joining a group, a community, a forum, a chat event, any event; Triggering authentication, identification, content and context interpretation, a survey or a voting or a bet, through or over a television or a monitor screen, or printed item; Triggering a rich media content which may be audio, video, photo, any other known, or yet unknown rich media product; Triggering the recording of rich media content, the playback of rich media content, payment functions, a communication function which may be a phone call an online call, a voice over IP call, an SMS, a text message, an instant message, an e-mail; games; shopping services; Any performance delivery, and any online activity or filtered information resulting directly from the use and the structure of the system, or of custom source.

All performances may also be triggered by so-called beam functions via notifications, which, when started or opened, can also trigger these performances.

Main Concepts

Fyuuuzing—Contrary to the traditional log-on policy of communication channels, where the user is defined as a person, and a link is established between two persons, or between a person and a content, and the user must identify themselves within this context to invariantly to get access to a newly created possibly private channel. The invention aims to grant a relevance based, multiple context related access to already existing channels via a user dependent challenge of instant digital code detection, recognition and identification. Effectively, it means that the communication channel is already predefined, or may be cloned from a pool of similar resources, but blocked until the user participant with a fitting-key attempts to encipher its challenge. Moreover, the recognition and interpretation of the provided digital information can be encoded into a barcode, a QR code, human face recognition, a company logo, an image, or a physical location. The recognition and interpretation of the provided digital information can also eventually be encoded with a corresponding direction vector, or an exact point of time or time period, or in the extreme cases any other physically materializable virtual coordinate that is a signal. However once it has been given a context, it is a “fyuuuz label”. This “fyuuuz label” is assisted during the corresponding negotiation process by the parameters and properties of the user's corresponding party's physical and cyber context in such a way that in the end the access will be highly personalized, and precisely defined. As a side effect conclusion the user's current context will also be defined, thus the correlation of the corresponding parties will be adjusted and individually updated. Therefore, the correlation, and the interactions between among participants the users and the system and among the users, are always understood in a two-way direction always in an individualized and unique manner. This process offers the human users and opportunity to evolve their social relations based upon defined and specified context relevant criteria that take trends, preferences, friendships etc into account. As a result the same interaction steps may lead to different communication, or data traffic end results. These end results are always dependent on the context of the interacting users' corresponding components as well as relevantly considered and related criteria in the global state of the system.

Profiles

All profiles may have different contexts, thus an owner of a profile may have different aliases. A living person may have one or more profiles with different profile criteria, or one or more named profiles with different profile criteria, which will be anonymous if the participant doesn't provide their real identity. Thus, one person may appear as different profiles and aliases to other participants. All aliases may target and be targeted, and a participant may switch any time between the aliases and participate in the system in its actual semantic context. Exchanging information can also be also anonymous. A user can decide, when calling another user, sending an SMS or an e-mail the System to hide and does not show or reveal the recipient's phone number or e-mail address to the sender. Same when receiving a call, an SMS or an e-mail: phone numbers and e-mail addresses are hidden.

The main identifier of a registered participant in general as a living person is a number provided by the respective SIM card in the respective device, which usually is a phone number, or by the participant, which is also meant to function as a real phone number. This number connects the aliases. Each alias has their own profile settings; each represents different aspects of the participant's characteristic, or personality. The aliases are identified in the system by the SuperID, which is an internal system identifier of the registered participants.

At registration, the system creates a user and assigns a serial number to each user. This number may consist of a combination of numbers and characters which can be the user's country code as reported by the user's mobile device and a combination of number or numbers/characters. This will be the default display name of the user for all his/her aliases if the participant wishes not to provide their identity by a name and remain anonymous. Other participants, however, have the option to change the serial number to a name or another combination of characters/numbers, or to add one in addition to the serial number, or rename a participant. An endless number of devices apply. This means that the application can be installed on a device that does not have a SIM card, or a phone function. When installing the application on devices with no SIM card, the mobile phone number provided for the mobile device with a SIM card and a phone function will be the identifier for the user. When sending an SMS to, or calling another user, the functions will be executed by the mobile device that has the phone and SMS functions.

Interactions within fyuuuz are always semantically determined. These interactions may have different outputs. The log-on screen provides a barcode challenge on screen to the user. Registered Fyuuuz users can read it in via their mobile devices because their context already includes their registered status, so they will land on their personal launching site both within the browser and within the mobile app.

Automated Engagement and Community Building

Automated engagement with the label owner, and/or getting into, or joining a group that had been previously created and specified by a participant, a particular user or a company. The candidates only have to rely on a particular fyuz operation which automatically logs them in into the pool of the privileged member participants. For an engagement, candidates must meet the relevance criteria through their context, in this case the entry requirements. In effect, the interaction could be the recognition of a QR code or of a face of a film star representing e.g. a marketing campaign to let people join for a common cause, or any other context in relation to the context of the situation. This can be a very good means for interactive marketing or organic build-up of a group of people with common interest.

Sending instant messages, pictures, videos, data etc. between user participants is also reliant on their actual bilateral context levels if they have are already fyuuuzed in fusion with each other, or with somebody of a potential participant from their contact lists. The result of operation correspondence opportunities is also dependent on this relationship. More precisely, sending recommendations to/by a company to other participants is not possible unless it has been fyuuuzed by the user. In this case the company and the targeted participants must be in fusion (and of course accepted by the company!), but only general facts and some information are available. For an additional fee, companies can accept users. Targeting opportunities may be related to or dependent on fees that can be applied and elastically scaled in the number of participants. The context of a particular user participant counts SEMANTICALLY at a prompt moment and replaying it later might not work as in a television show, a survey, a call-in contest, a newspaper, or a TV advertisement.

Virtual Interaction through Physical Reality

Current user interactions are either physically bound according to traditional rules of human interplay, or almost totally take place in a virtual cyber space between user representing avatars, although augmented reality has started to play an ever increasing role in future social interaction of daily activities. Contrary to these trends, the roles of the participating means of interactions must be inversed. In other words the interaction seems to be physically executed to the user, but in reality the parameters of the interaction are exchanged though the cyber connection. In essence, fyuuuz is an augmented cyberspace. The technical solution relies on an in-band or out-band information stream that is hardly recognizable to the user, but their mobile is always perfectly aware of the information stream based on the actual context of the user and the “fyuuuz label” provided by the corresponding main communication channel(s) it initializes the fusing on behalf of the user.

Physical reality cheats the user, but provides them a physical (analog) context that mixes with their virtual context. The fyuuuying operation in the end takes place between a user's mobile and the system through a lossless digital channel.

### Examples

The method induces a scenario that enables TV Format owners or Television Broadcasters to operate a “multiple second screen: a smart screen”, through integrating a signal into the broadcasted signal, e.g. a visual on the TV screen. If the signal labeled, that is has been added a context then multiple actions are possible, which allow different profile criteria definitions. Thus one signal will be converted into multiple, different outputs, so that viewers with different profiles will have a different user experience, to experience a different performance. Performances may also be triggered by the so called beam functions, via notifications which, when started, or opened, also trigger these multiple performances.

Interactive targeted marketing via TV screen: a visual signal appears, indicating that the actual TV program is interactive. By directing their mobile at the screen, the users can fyuz with the information channel that is embedded in the media stream. Although it seems that the mobile recognizes a digital code within the main media stream by its physical analogue representation, in reality only approximate image recognition is necessary to get the user's physical context and then the actual communication between the user and the system will take place through a digital channel via fyuuuzing operations.

Multi-source media interaction: the user selects a picture or a video that has already been registered/fyuuuzes in the system on screen e.g. within a browser or a billboard, and directs their mobile at it. Then, the user manipulates its size, crop, visibility, visual effects etc. by simply moving their mobile device. (For example taking the ambient light, or letting the mobile approximate the user's inverse axonometric position etc.) When the users are ready, they select which of their friends should receive the picture and then lets their mobile “take the picture” of the scenery. However, in effect only the user's physical context related to the picture and the embedded digital code within the image will be sent in a truly digital format to the system where all image processing tasks takes place to the perfection and then an ordinary fyuuuzing operation happens with their friends.

Community branding of information/service/product: participants provide other participants the opportunity to leave their brand logo(s) or services/products on their fyuuuz presence sites making them available for any other users to get fyuuuz with. In effect, a branding or advertising hierarchy will be created in such a way that major brands assist minor ones to go ahead with their ranking in exchange for some explicit rewards. The rewarding mechanism functions exactly as described in the previous case; however, the asset to distribute is some own place available for the other brands to get visibility instead of concrete pieces of information content.

Payment and Incentive Solutions

Channel: all participants automatically get the right to install channels according to their preferences. Thus when a participant wants to send or publish some information or share some content elements, they are entitled to define the corresponding channel(s) and lets the other participants fyuuuz on it/them.

Automated Community Building. A signal is labeled as a log into and/or joining a group or a community or a network. There is the option to activate the community building feature, so that the context of the label is “log into group” which means that in the moment a participant fyuzes with the particular label, this participant will be included into the community of the label owner or of the participant the group is assigned to. The activation of the automated community building feature refers to a specified group assigned to a participant. The label may appear on the display of the group member's device, so other participants can fyuz and join the group the specific label being displayed is assigned to. Example: a signal is displayed on the TV screen. Family members watching TV can fyuz with the signal. The signal has a multiple second screen definition, and the adult members of the family will be automatically included into the group becoming a group member with other participants who are or will be members of this group. Younger members of the family, e.g. under 18 years may experience a different context of the same signal, and a different performance. Participants may be included into various groups, due to the multiple context and multiple performance possibilities. Example: same previous TV scenario or an event. Participants attend an event, like a cultural festival, and they fyuz with e.g. the festival group label at the entrance or any other location. Some may log into the group of 13-16 years, 16-18 years, 18-29 years, or of any other specifications.

The group login feature, and the execution of the logging in and joining of a group may be attached to any other functionality, like the triggering of a chat scenario, a shopping scenario, a survey, a voting or a betting scenario, or any other scenario like playback of an audio, video, photo or text content, or any other functionality, context or performance. The group login feature may also be triggered by a notification.

“Multiple, Personalized Second Screen” Application for the direct and instant monetization of TV viewers, and media content consumers: A signal displayed or delivered over a TV screen, a billboard, print, or an audio source triggers different performances according to the context of the signal and, the possibly multiple targeting definitions of the label, and the performance or performances added. Example: Family watches TV, every member fyuzes with the TV screen at the same, or at different times, and different family members fyuzing at the same time may experience a different context, and a different performance than others, or the same ones fyuzing at different times my do the same. This is due to the ability of multiple contexts and performances executions added to the same, meaning just one signal. The delivery service, meaning the establishment of the connection between the user and the content, or the content itself may be charged for either once for purchasing, each time for viewing, or on a watched time basis.

Survey, voting, betting features are performances triggered by a labeled signal or a notification. The execution of these performances may have a fee. Example: A labeled signal appears on the TV screen or on any kind of visual, all family members fyuz with the same signal, however some will be experiencing a survey, others a voting, while others a betting. The fee for voting is set prior to fyuzing, and if done so, the fyusers may accept or not accept the fee, and if they do, their system currency account will be charged the equivalent or corresponding amount of system currency. Operational functional buttons are built into and displayed by the application, and the communication with the server is operated by these buttons, and not over on online connection with a web page.

“Branded Entertainment” is “Entertaining Brands” which is a new method, and a new user experience: As opposed to the traditional way of communicating, delivering a marketing message, placing a brand or a product into an entertaining environment where ads or messages were placed in and around a rich media environment to reach, target consumers, or a specific group of the relevant and/or equivalent consumer demographics of a specific product, fyuuuz provides an intelligent, new and efficient method of rich media content delivery and distribution, though the brands and products themselves, through fyuzing with the brand, or the product package, or its barcode. This method allows the placement of rich media content around brands and products, and the direct and instant monetization of targeted consumers.

Interactive, Personalized Advertisement. Example: Sell the product over the TV screen, over the billboard or over the print advertisement. Don't sell just the message, but sell product. A signal displayed or delivered over a TV Screen, a billboard, print, or an audio signal source, they can buy the service or the product instantly.

Domestic System Currency Implementation

The System uses an own system currency, called fyuuuz bucks (FYB) and fyuuuz coins (FYC).

Scalable payment implementation: products, communication activities, performances and fyuuuz actions may be attached to a toll payment option. Participants of the system may publish products or offer services/behavior at a particular price, scalable to their preferences. Hence users are allowed to price their rich media content, their information assets and/or data, as well as their fyuuuz communication actions and performance delivery. They may do the same via so called beam functions in any external internal system format of currency. The scalable payment function however, also allows participants to scale and set an amount as a reward payment to the recipient participant.

Reward Solutions: there is two-way reward enacting mechanism within the system. On the one hand, already available information contents/products are sold via an auto-progressing valorization and price sharing mechanism; on the other hand, promises in the form of hierarchical product branding or vouchers are arranged in a hierarchical multi-advertising manner.

The basic concept of the invention relies on the fact that participants can be targeted by allowing other participants to send them notifications, or any kind of information, content or data, and doing so they are rewarded by letting them earn a pre-set percentage of the money that the sender is willing to pay to the service provider for the service. Based on this foundation the value sharing schemes are the following:

Donation: the donation feature allows system participants to donate system currency to each other. This means that one participant may donate (transfer, send, place) any amount of system currency from their account to the account of another participant. This can be a reward, in exchange for a certain performance experience, e.g. rich media content, but also in exchange for information.

Community valorization of existing information/service/product, reward system by donation: participants sending any information, data and/or content to other participants donate an amount, that is pay a reward fee to the initial participant being the initiator of the information on the first level of the information flow. The recipient of this first step residing on the second level of the information flow may send this information further to other participants, who are on the third level of the information flow. Then, these recipients will pay a 100 percent fee for the received information and a certain percentage of this amount will be sent to the initial participant, who initiated the information, another percentage to the second participant, and rest goes to the system provider. This reward mechanism repeats itself on farther levels of the information flow which finally find all participants having an interest in the original information. In the end, the original provider of the information will get the total valorization of her service/product in the community of the participants. Moreover, every recipient will pay a 100 percent fee though a certain percentage of it will be paid to the initial participant, another certain percentage to the dispatching participants on the previous level of the flow of information, and the rest to the system provider.

I claim:

1. A method for personalized media content distribution and consumption on a mobile telephone comprising:
detecting and interpreting a signal that previously has been given one or more functional contexts in order to display at least one performance to a viewer according to predefined specifications defined for said signal;
wherein said signal is one from the group selected from digitally detecting the face of a person, digitally detecting a sound, detecting a bar code, and detecting an object;
outputting at least one predetermined performance to a recipient via a mobile telephone based on the signal.

2. The method of claim 1, further comprising adding new outputs to the at least one predetermined specification for a signal.

3. The method of claim 1, wherein said signal is user profile created by the recipient.
